(19) United States
(12) Patent Application Publication
(10) Pub. No.: US 2012/0119945 A1
(43) Pub. Date: May 17, 2012

(54) SATELLITE ORBITAL DATA COMPRESSION METHOD, SATELLITE ORBITAL DATA PROVIDING METHOD, SATELLITE ORBITAL DATA EXPANSION METHOD, SERVER, AND POSITIONING APPARATUS

(75) Inventor: Kyoichi TOMITA, Yokohama (JP)

(73) Assignee: SEIKO EPSON CORPORATION, Tokyo (JP)

(21) Appl. No.: 13/357,886

(22) Filed: Jan. 25, 2012

Related U.S. Application Data
(63) Continuation of application No. 12/498,617, filed on Jul. 7, 2009.

(30) Foreign Application Priority Data
Jul. 25, 2008 (JP) 2008-192520

(51) Int. Cl. G01S 19/01

(52) U.S. Cl. 342/352

(57) ABSTRACT

A compression method of satellite orbital data includes: calculating an estimate value of a first parameter from a predetermined calculation using either another parameter value or a first parameter in a different unit term, and replacing the first parameter value with the difference value between the estimate value and the first parameter value.

### CROSS-REFERENCE TO RELATED APPLICATIONS

This is a continuation application of U.S. patent application Ser. No. 12/498,617, which claims priority to Japanese Patent Application No. 2008-192520 filed on Jul. 25, 2008. The entire disclosure of U.S. patent application Ser. No. 12/498,617 and Japanese Patent Application No. 2008-192520 is hereby incorporated herein by reference.

### BACKGROUND

1. Technical Field

The present invention relates to a satellite orbital data compression method and the like.

2. Related Art

As a positioning system using a positioning signal, a global positioning system (GPS) is widely known, and is used as a positioning apparatus incorporated in, for example, a portable phone or a vehicle navigation system. The GPS executes a positioning calculation to obtain values of four parameters, namely three-dimensional coordinate values representing the location of the apparatus and a clock error, based on information such as the locations of a plurality of GPS satellites and pseudo-ranges between the GPS satellites and the apparatus, thereby performing positioning.

In the positioning by the GPS, the satellite information such as positions, speeds, or moving directions of the GPS satellites is calculated based on the navigation data such as an almanac or ephemeris overlapped with the GPS satellite signals transmitted from the GPS satellites, and the positioning calculation is executed using the satellite information and time information. In particular, the ephemeris provides important clues to capture the satellite, and therefore, when starting positioning with no ephemeris, for example, the time to first fix (TIFF) increases. Further, even when it is not the first fix, when first capturing a certain satellite, the capturing time significantly varies depending on whether or not the ephemeris of the satellite is instantly available.

The document by SiRF Technology, Global Locate, Nokia Siemens, Motorola, Nokia, Alcatel-Lucent, RIM, AT&T, entitled “A-GNSS, Orbit Extension,” presented at the 3GPP TSG-GERAN Meeting #34 Shenzhen, China, May 14th to 18th, 2007, which can be found online at <URL: http://www.3gpp.org/ftp/tsg_geran/TSG_GERAN/GERAN_{—}34_Shenzhen/Docs/GP070866.zip>) discloses a technology related to the ephemeris (hereinafter referred to as “long-term predicted ephemeris” (predicted satellite ephemeris) valid for a long period of time. A long period of time preferably means longer than at least one day.

The technology disclosed in “A-GNSS, Orbit Extension” relates to a technology for reducing the amount of data of the long-term predicted ephemeris. Specifically, the satellite orbit in every six-hour term (hereinafter referred to as a “unit term”) is expressed by the model formula of the Kepler's elliptical orbit, and the coefficients (hereinafter referred to as “satellite orbital parameter values”) used in the model formula are used as the ephemeris. Since the data in every six-hour are used, the data of one whole day can be obtained by generating four sets of satellite orbital parameter values.

Considering the data of one whole day as the long-term predicted ephemeris, the parameter values of the first unit term are used as a base (hereinafter referred to as a “base unit term”) to replace the satellite orbital parameter values in the remaining three unit terms with respective deltas from the satellite orbital parameter values in the base unit term, so that the amount of data of the entire long-term predicted ephemeris is reduced.

However, there is a demand for further reduction in the amount of data of the long-term predicted ephemeris. Specifically, in the envisioned usage pattern of the long-term predicted ephemeris, the long-term predicted ephemeris is downloaded from the server system and used by a positioning apparatus. Therefore, there is a demand to reduce the amount of data of the long-term predicted ephemeris, thereby reducing the communication time and the amount of communication.

### SUMMARY

In view of the problem described above, the invention has an advantage of proposing a novel method that reduces the amount of data of the long-term predicted ephemeris.

A compression method according to a first aspect of the present invention includes the steps of calculating an estimate value of a first parameter based on either a different parameter value or a first parameter value in a different unit term, and replacing the value of the first parameter with the difference value between the estimate value and the first parameter value, the first parameter value being a parameter that can be estimated from a predetermined calculation and among one of the parameter values in the first unit term of the satellite orbital data, the satellite orbital data including the parameter values approximating the satellite orbits for consecutive unit terms.

According to the first aspect of the invention, an estimate value of a first parameter is calculated based on either a different parameter value or a first parameter value in a different unit term, the first parameter value being a parameter that can be estimated from the predetermined calculation and among one of the parameter values in the first unit term of the satellite orbital data, the satellite orbital data including the parameter values approximating the satellite orbits for consecutive unit terms. The value of the first parameter is replaced with the difference value between the estimate value and the value of the first parameter, thereby compressing the satellite orbital data.

When the original value of the parameter is compared with the difference value between the original value and the estimate value, the difference value is significantly decreased in data size. and hence, for the parameter values approximating the satellite orbits that can be estimated from the predetermined calculation, forming the satellite orbital data with the replaced difference values significantly reduces the data size.

In this case, according to a fifth aspect of the present invention, it is preferable to include the steps of calculating an estimate value among the parameters of the satellite orbital data including values of parameters approximating satellite orbits in consecutive unit terms with respect to a value of a first parameter which can be estimated by a predetermined calculation, and replacing the value of the first parameter with a difference value between the estimate value and the value of the first parameter.

Further, according to a second aspect of the present invention, it is preferable to configure the compression method to include, in addition to the steps of the first aspect of the invention, the step of replacing a second parameter value with the difference value between the second parameter value and a second parameter value in a different unit term, the second parameter of which cannot be estimated from the predetermined calculation.

According to the second aspect of the invention, the satellite orbital data size can be reduced by replacing the second parameter value, which cannot be estimated from the predetermined calculation, in the first unit term with the difference value between the second parameter value and a second parameter value in a different unit term.

In this case, according to a third aspect of the present invention, it is preferable to include the step of providing a positioning apparatus with the satellite orbital data compressed by the compression method of the first aspect of the invention.

Further, according to a fourth aspect of the present invention, it is preferable to configure an expansion method of the satellite orbital data that restores the satellite orbital data that have been compressed accordingly to the first or second aspect of the invention to the original satellite orbital data, the expansion method including the steps of obtaining an estimate value of the first parameter value from the predetermined calculation, the first parameter value being the parameters included in the compressed satellite orbital data, and calculating the first parameter value using the estimate value and the difference value between the estimate value and the first parameter value.

According to the fourth aspect of the invention, the estimate value of the first parameter among the parameters in the compressed satellite orbital data is obtained from the predetermined calculation. The first parameter value is then obtained using the estimate value thus obtained and the difference value in the compressed satellite orbital data. Thus, the satellite orbital data compressed accordingly to the compression method of the first or second aspect of the invention can be expanded.

Further, according to a sixth aspect of the present invention, it is preferable to configure a server including an estimation section adapted to calculate an estimate value of a first parameter based on either a different parameter value or a first parameter value in a different unit term, a compression section adapted to compress the satellite orbit data by replacing the first parameter value with the difference value between the estimate value and the first parameter value, the first parameter value being a parameter that can be estimated from a predetermined calculation and among one of the parameter values in the first unit term of the satellite orbital data, and a providing section adapted to provide the compressed satellite orbit data to a positioning apparatus, the satellite orbital data including the parameter values approximating the satellite orbits for consecutive unit terms.

According to the sixth aspect of the invention, it is preferable to realize a server adapted to provide to a positioning apparatus the satellite orbital data compressed accordingly to the compression method of the first or second aspect of the invention.

Further, according to a seventh aspect of the invention, it is preferable to configure a positioning apparatus including an estimation section adapted to obtain an estimate value of the first parameter from the predetermined calculation, the first parameter being a parameter in the satellite orbit data which is compressed accordingly to the compression method of the first or second aspect of the invention, a calculation section adapted to calculate the first parameter value using the estimate value and the difference value between the estimate value in the compressed satellite orbital data and the first parameter value, and a positioning section adapted to execute positioning using the calculated value of the first parameter.

According to the seventh aspect of the invention, it is preferable for a positioning apparatus to execute positioning by capturing the satellites using the satellite orbital data that has been expanded accordingly to the expansion method of the fourth aspect of the invention.

### BRIEF DESCRIPTION OF THE DRAWINGS

Referring now to the attached drawings which form a part of this original disclosure, the invention will be described with reference to the drawings, wherein like numbers reference like elements:

FIG. 1 is a view of a diagram showing a schematic configuration of a positioning system in accordance with a preferred embodiment of the present invention;

FIG. 2 is a view of a block diagram showing a functional configuration of a server system of the positioning system;

FIG. 3 is a view of a diagram showing an example of data stored in a ROM of the server system;

FIG. 4 is a view of a diagram showing an example of data stored in a hard disk of the server system;

FIG. 5 is a view of a diagram showing an example of a data configuration of the predicted satellite ephemeris on the server system;

FIG. 6 is a view of a diagram showing an example of a data configuration of the complete long-term predicted ephemeris data on the server system;

FIG. 7 is a view of a diagram showing an example of a data configuration of the predicted ephemeris in the 1st through 28th unit terms;

FIG. 8 is a view of a diagram showing an example of a data configuration of the compressed long-term predicted ephemeris data on the server system;

FIG. 9 is a view of a diagram showing an example of a data configuration of the predicted ephemeris in the base unit term;

FIG. 10 is a view of a diagram showing an example of a data configuration of the compressed predicted ephemeris in the 2nd through 28th unit terms;

FIG. 11 is a view of a flowchart showing the flow of a compressed long-term predicted ephemeris providing process;

FIG. 12 is a view of a flowchart showing the flow of a compressed long-term predicted ephemeris generation process;

FIG. 13 is a view of a flowchart showing more of the flow of a compressed long-term predicted ephemeris generation process;

FIG. 14 is a view of a block diagram showing a functional configuration of a portable phone of the positioning system;

FIG. 15 is a view of a diagram showing an example of data stored in a ROM of the portable phone;

FIG. 16 is a view of a diagram showing an example of data stored in a flash ROM of the portable phone;

FIG. 17 is a view of a diagram showing an example of data to be stored in a RAM of the portable phone;

FIG. 18 is a view of a flowchart showing the flow of a main process;

FIG. 19 is a view of a flowchart showing the flow of a first fix speeding-up process; and

FIG. 20 is a view of a flowchart showing the flow of a second compressed long-term predicted ephemeris providing process.

### DETAILED DESCRIPTION OF THE PREFERRED EMBODIMENTS

Hereinafter, an example of a preferred embodiment of the invention will be described with reference to the accompanying drawings. It should be noted that the embodiment to which the invention is applied is not limited to the preferred embodiment.

### 1. System Configuration

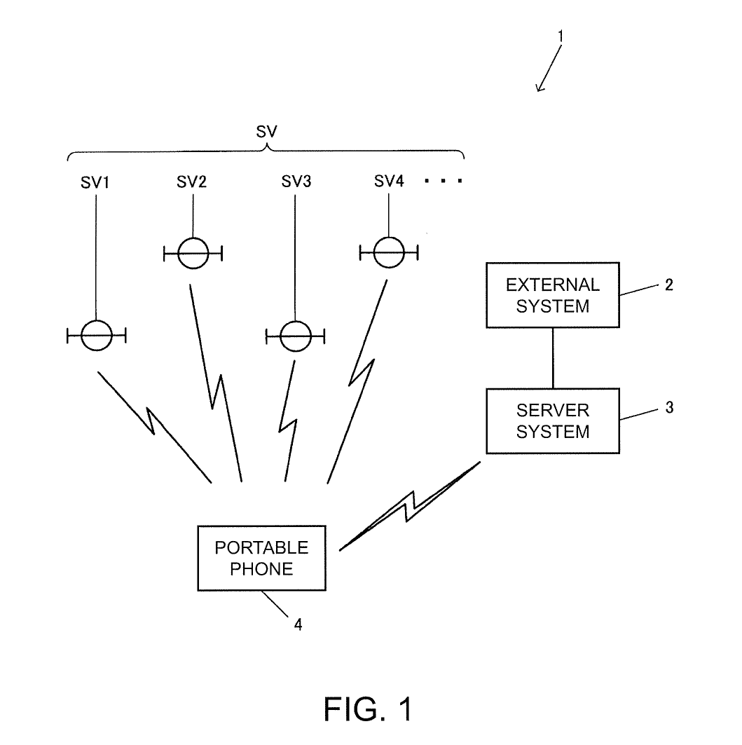

FIG. 1 is a view of a block diagram showing a schematic configuration of a positioning system 1 according to the present embodiment. The positioning system 1 is configured to include an external system 2, a server system 3, a portable phone 4 as electronic equipment provided with a positioning apparatus, and a plurality of GPS satellites SV (SV1, SV2, SV3, SV4, . . . ).

The external system 2 is a system that periodically receives the satellite signals from the GPS satellites SV, and generates the predicted satellite ephemeris based on the navigation data and so on included in the satellite signals to provide the predicted satellite ephemeris to the server system 3. The predicted satellite ephemeris the external system 2 provides is a group of discrete data having the satellite positions arranged in a time-series manner with respect to each of the GPS satellites SV, and is discrete position data. The external system 2 corresponds, for example, to a computer system of a private or public entity with the business of providing the predicted satellite ephemeris.

The server system 3 is a system equipped with a server that obtains the predicted satellite ephemeris from the external system 2, and generates and provides the ephemeris (hereinafter referred to as a “long-term predicted ephemeris (a predicted satellite ephemeris)” in the present embodiment) valid for a long period of time, preferably longer than at least one whole day, and more preferably for at least a week, and predicted with respect to all of the GPS satellites SV using the predicted satellite ephemeris.

In the present embodiment, the server system 3 generates the long-term predicted ephemeris (hereinafter referred to as a “compressed long-term predicted ephemeris”) with a compressed form storing the compression values of the satellite orbital parameters based on the long-term predicted ephemeris (hereinafter referred to as a “complete long-term predicted ephemeris”) with a complete form storing the original numerical values of the satellite orbital parameters. Here, the “original numerical value” means an original value but not a compression value described later. Further, the compressed long-term predicted ephemeris thus generated is transmitted to the portable phone 4 from which a request signal is received.

The portable phone 4 is electronic equipment for the user to make a phone call or to transmit or to receive an email, and is provided with a function (positioning function) of measuring the position in addition to the original functions as the portable phone such as a phone call or transmission/reception of an email. The portable phone 4 transmits the request signal for the compressed long-term predicted ephemeris to the server system 3 in accordance with the user operations, and then receives the compressed long-term predicted ephemeris from the server system 3. Subsequently, the portable phone 4 expands the compressed long-term predicted ephemeris thus received to obtain the complete long-term predicted ephemeris, and to perform positioning by capturing the GPS satellites SV using the complete long-term predicted ephemeris.

### 2. Server System

### 2-1. Functional Configuration

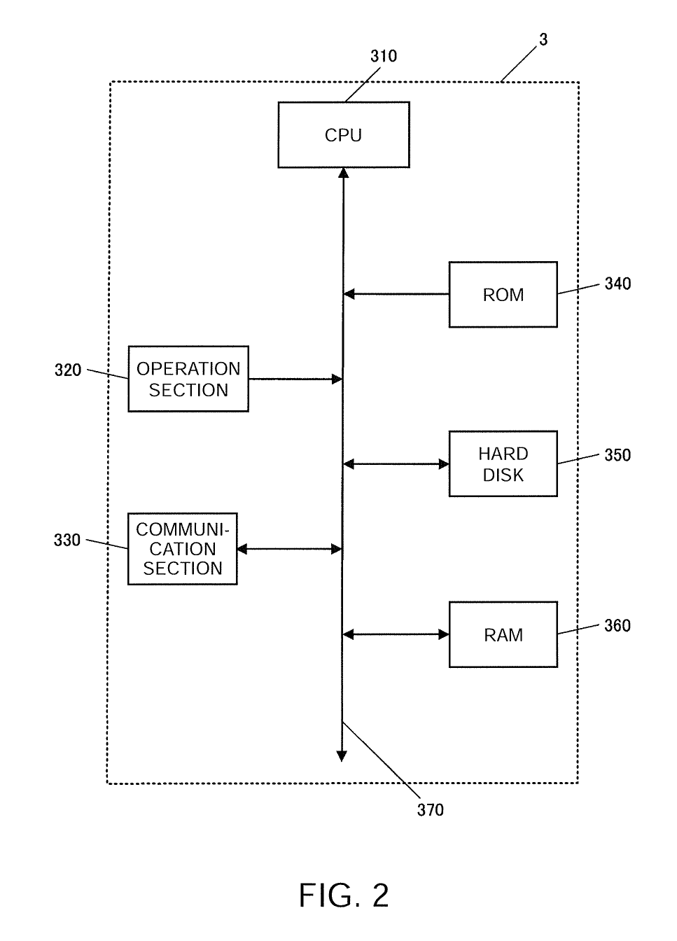

FIG. 2 is a view of a block diagram showing a functional configuration of the server system 3. The server system 3 is a computer system having a central processing unit (CPU) 310, an operation section 320, a communication section 330, a read only memory (ROM) 340, a hard disk 350, and a random access memory (RAM) 360, all connected to each other via a bus 370.

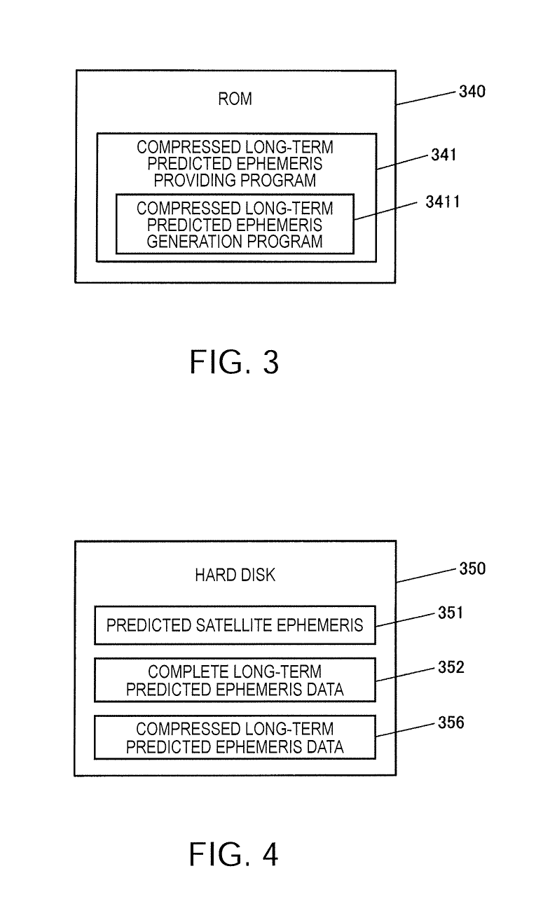

The CPU 310 is a processor that integrally controls each of the sections of the server system 3 along a system program stored in the ROM 340. In the present embodiment, the CPU 310 performs a process that provides the portable phone 4 with the compressed long-term predicted ephemeris along a compressed long-term predicted ephemeris providing program 341 stored in the ROM 340 as shown in FIG. 3.

Referring again to FIG. 2, the operation section 320 is an input device, which outputs, when receiving an operation instruction by the administrator of the server system 3, a signal corresponding to the operation to the CPU 310. This function is realized by, for example, a keyboard, a button, or a mouse.

The communication section 330 is a communication device that communicates various kinds of data used inside the system with the external system 2 or the portable phone 4 via a communication network such as the Internet.

The ROM 340 is a read-only nonvolatile storage device, and stores various kinds of programs such as a system program for the CPU 310 to control the server system 3, a program that provides the portable phone 4 with the compressed long-term predicted ephemeris or a program that generates the compressed long-term predicted ephemeris, data, and the like.

The hard disk 350 is a storage device that performs reading and writing of data using a magnetic head or the like, and stores the program to realize various functions provided to the server system 3, data, and so on similarly to the ROM 340.

The RAM 360 is a readable and writable volatile storage device, and forms a work area that temporarily stores the system program, a compressed long-term predicted ephemeris providing program, and various kinds of processing programs executed by the CPU 310, and in-process data and process results of the various kinds of processes.

### 2-2. Data Configuration

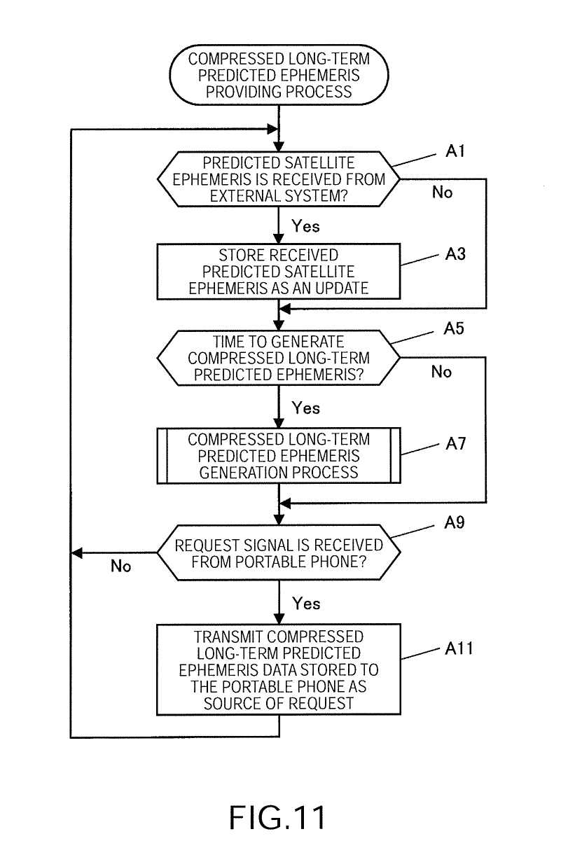

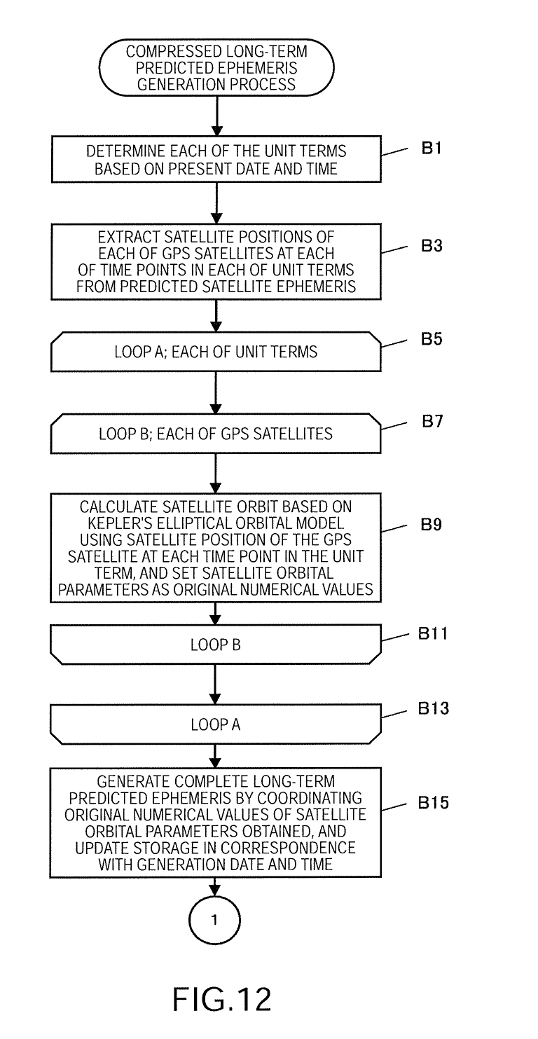

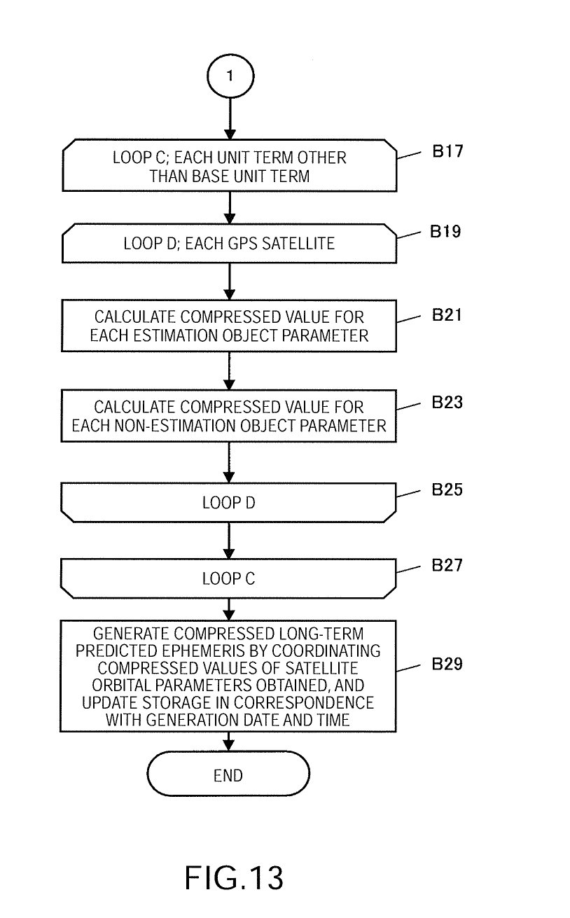

FIG. 3 is a view of a diagram showing an example of the data stored in the ROM 340. The ROM 340 stores the compressed long-term predicted ephemeris providing program 341 read by the CPU 310 and executed as a compressed long-term predicted ephemeris providing process (see FIG. 11). Further, the compressed long-term predicted ephemeris providing program 341 includes, as a subroutine, a compressed long-term predicted ephemeris generation program 3411 executed as a compressed long-term predicted ephemeris generation process (see FIGS. 12 and 13).

Referring to FIGS. 1 and 2, the compressed long-term predicted ephemeris providing process denotes a process in which the CPU 310 periodically executes the process to generate the compressed long-term predicted ephemeris, and upon receiving the request signal for the compressed long-term predicted ephemeris from the portable phone 4, transmits the compressed long-term predicted ephemeris thus generated to the portable phone 4 as the source of the request. The compressed long-term predicted ephemeris providing process will be explained later in detail using a flowchart.

The compressed long-term predicted ephemeris generation process denotes a process in which the CPU 310 generates the compressed long-term predicted ephemeris. Specifically, based on the satellite positions of the respective GPS satellites SV stored in the predicted satellite ephemeris received from the external system 2, the CPU 310 calculates the satellite orbit in each unit term of every six hours with respect to each of the GPS satellites SV using the Kepler elliptical orbit model as a base, thereby generating the complete long-term predicted ephemeris having the original numerical values of the satellite orbital parameters. Subsequently, the CPU 310 generates the compressed long-term predicted ephemeris having the compression values of the satellite orbital parameters using the complete long-term predicted ephemeris thus generated as a base.

In the present embodiment, the CPU 310 generates a compressed long-term predicted ephemeris every four hours. Specifically, the term from the generation time of the compressed long-term predicted ephemeris as a base up to a week later is defined as a prediction term, and each of the 28 terms obtained by dividing the one-week term by six hours is defined as the unit term. Then, the CPU 310 generates the complete long-term predicted ephemeris and the compressed long-term predicted ephemeris composed of the predicted ephemeris corresponding to the 28 unit terms.

FIG. 4 is a view of a diagram showing an example of the data stored in the hard disk 350. The hard disk 350 stores the predicted satellite ephemeris 351, complete long-term predicted ephemeris data 352, and compressed long-term predicted ephemeris data 356.

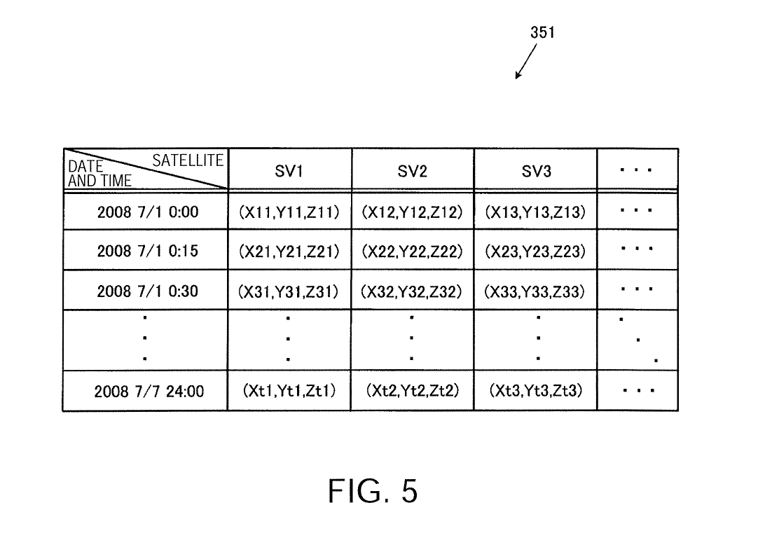

FIG. 5 is a view of a diagram showing an example of data configuration of the predicted satellite ephemeris 351. The predicted satellite ephemeris 351 is discrete data storing the satellite positions for each of the GPS satellites SV in 15 minute intervals for a week. The satellite position is represented, for example, by three-dimensional coordinate values in a terrestrial reference frame. For example, the satellite position of the GPS satellite “SV2” at “2008 7/1 0:30” is “(X32, Y32, Z32).”

Referring again to FIGS. 1, 2, and 3, the CPU 310 updates the predicted satellite ephemeris 351 in the hard disk 350 with the predicted satellite ephemeris 351 periodically (e.g., every four hours) transmitted from the external system 2. Subsequently, in the compressed long-term predicted ephemeris generation process, the CPU 310 calculates, with respect to each of the GPS satellites SV, the satellite orbit (the original numerical values of the satellite orbital parameters) of the present GPS satellite based on the Kepler approximation model using the satellite position stored in the predicted satellite ephemeris 351 as a sample point.

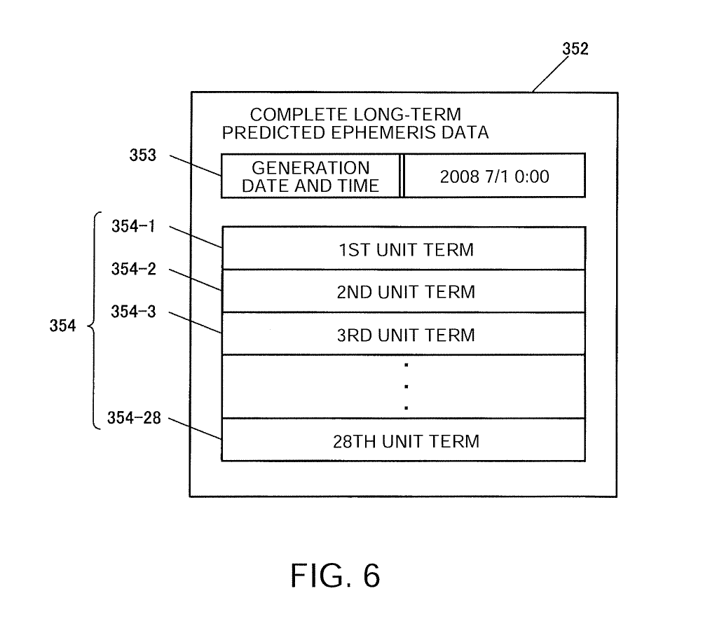

FIG. 6 is a view of a diagram showing an example of a data configuration of the complete long-term predicted ephemeris data 352. The complete long-term predicted ephemeris data 352 stores the complete long-term predicted ephemeris 354 composed of predicted ephemeris 354-1 through 354-28 in the 1st through 28th unit terms corresponding to the generation time 353 of the complete long-term predicted ephemeris.

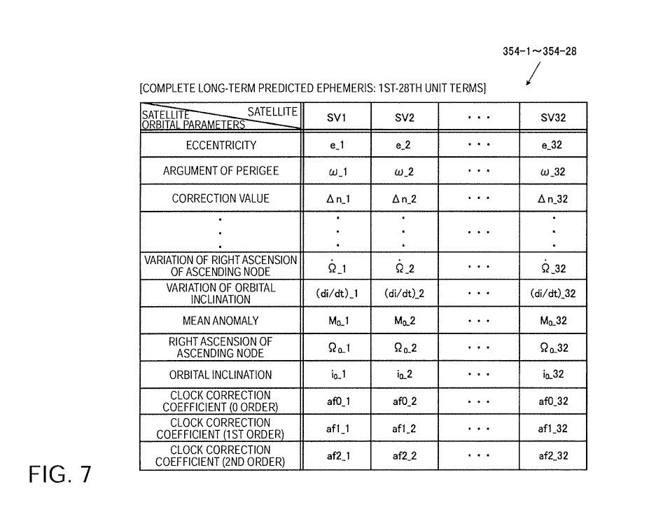

FIG. 7 is a view of a diagram showing an example of a data configuration of the predicted ephemeris 354-1 through 354-28 in the 1st through 28th unit terms. Each of the predicted ephemeris 354-1 through 354-28 stores the original numerical values (original values) of the Kepler satellite orbital parameters with respect to each of the 32 GPS satellites SV. For example, the original numerical value of the eccentricity calculated with respect to the GPS satellite “SV1” is “e_{—}1.”

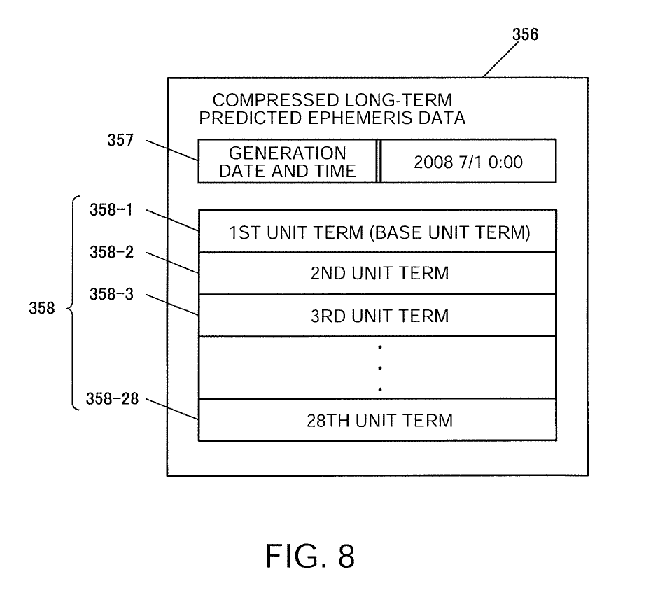

FIG. 8 is a view of a diagram showing an example of a data configuration of the compressed long-term predicted ephemeris data 356. The compressed long-term predicted ephemeris data 356 stores the compressed long-term predicted ephemeris 358 composed of the predicted ephemeris 358-1 in the first unit term, and the compressed predicted ephemeris 358-2 through 358-28 in the respective 2nd through 28th unit terms corresponding to the generation date and time 357 of the compressed long-term predicted ephemeris. In other words, the compressed long-term predicted ephemeris 358 has the predicted ephemeris in only the first unit term, and the compressed predicted ephemeris obtained by compressing the data of the predicted ephemeris in the rest of the unit terms. In the explanations hereinafter, the first unit term is referred to as a “base unit term.”

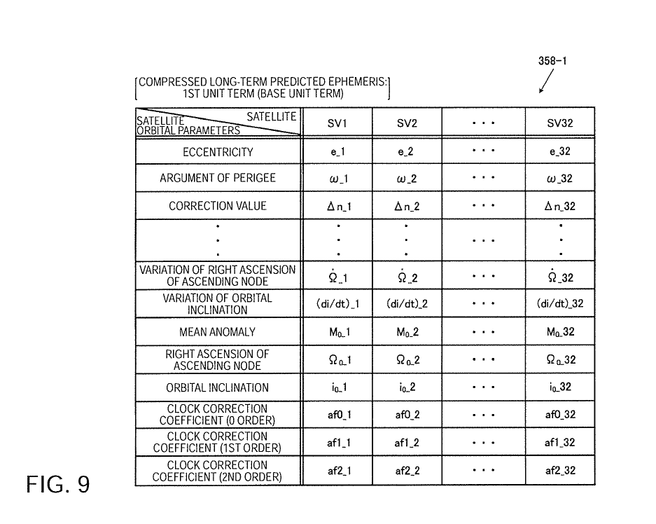

FIG. 9 is a view of a diagram showing an example of a data configuration of the predicted ephemeris 358-1 in the base unit term. The predicted ephemeris 358-1 stores the original numerical values of the Kepler satellite orbital parameters with respect to each of the 32 GPS satellites SV. The data of the predicted ephemeris 358-1 are in no way different from the data of the predicted ephemeris 354-1 included in the complete long-term predicted ephemeris 354.

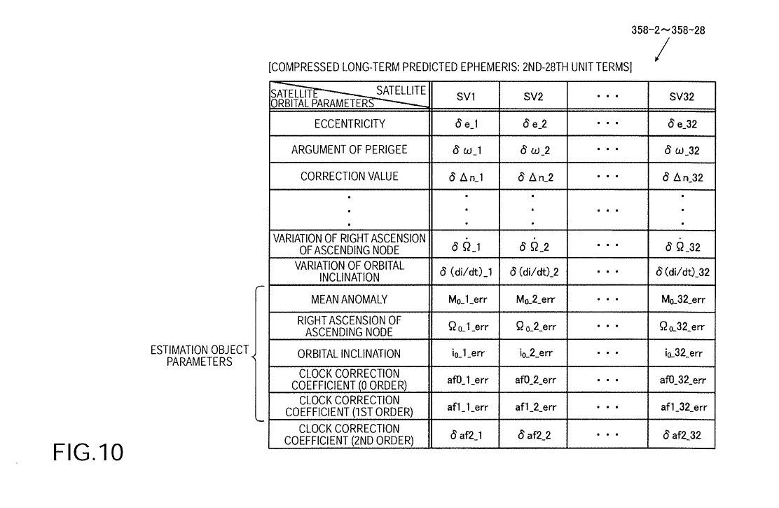

FIG. 10 is a diagram showing an example of a data configuration of the compressed predicted ephemeris 358-2 through 358-28 in the 2nd through 28th unit terms. Each of the compressed predicted ephemeris 358-2 through 358-28 stores the compression values of the Kepler satellite orbital parameters with respect to each of the 32 GPS satellites SV. The compression values are different between whether or not the corresponding satellite orbital parameter is a parameter the value of which can be estimated.

Among the satellite orbital parameters, mean anomaly “M₀,” right ascension of ascending node “Ω₀,” orbital inclination “i₀,” zero order clock correction coefficient “af0,” and first order clock correction coefficient “af1” can be estimated from a predetermined estimation calculation. These five parameters are referred to as “estimatable parameters,” and the parameters (i.e., the parameters unable to be estimated) other than the estimatable parameters are referred to as “non-estimatable object parameters.”

Specifically, the five estimatable parameters described above can be estimated by the following formulas 1 through 5.

$$\begin{matrix}{M}_{0}^{e} ( t + 1 ) = {M}_{0}^{e} ( t ) + ( \sqrt{\frac{μ}{{A}^{3}}} + Δ {n}^{a} ) \times d t & ( 1 ) \\ {Ω}_{0}^{e} ( t + 1 ) = {Ω}_{0}^{e} ( t ) + {\dot{Ω}}^{a} ( t ) \times d t & ( 2 ) \\ {i}_{0}^{e} ( t + 1 ) = {i}_{0}^{e} ( t ) + {( \frac{d i}{d t} )}^{a} \times d t & ( 3 ) \\ af {0}^{e} ( t + 1 ) = af {0}^{e} ( t ) + af {1}^{a} ( t + 1 ) \times d t & ( 4 ) \\ af {1}^{e} ( t + 1 ) = af {1}^{e} ( t ) + af {2}^{a} ( t ) \times d t & ( 5 )\end{matrix}$$

It should be noted that the superscript “e” represents that the symbol denotes an estimate value, and the superscript “a” represents that the symbol denotes an original numerical value. Further, “t” denotes a time point, and “dt” denotes a time difference. Further, “μ” and “A” are constants.

As is understood from the formula 1 through 5, the values of the estimatable parameters in the present unit term can be calculated using the estimate values of the estimatable parameters in the previous unit term to the present unit term, and the original numerical values of the non-estimatable parameters in each of the previous unit term to the present unit term and the present unit term. Since the complete long-term predicted ephemeris stores the original numerical values of all of the satellite orbital parameters in every unit term, by sequentially executing the estimation calculation from the second unit term, it is possible to obtain the estimate values of all of the estimatable parameters up to the 28th unit term.

In the present embodiment, with respect to the estimatable parameters, the differences from the original numerical values of the estimate values obtained in the procedure described above are calculated in each of the unit terms, thereby providing the compression values of the estimatable parameters. Specifically, the difference values between the original numerical values of the estimatable parameters are included in the complete long-term predicted ephemeris and the estimate values of the estimatable parameters, thereby providing the compression values.

M_{0—}err(t)=M₀^{a}(t)−M₀^{e}(t) (6)

Ω_{0—}err(t)=Ω₀^{a}(t)−Ω₀^{e}(t) (7)

i_{0—}err(t)=i₀^{a}(t)−i₀^{e}(t) (8)

af0_err(t)=af0^{a}(t)−af0^{e}(t) (9)

af1_err(t)=af1^{a}(t)−af1^{e}(t) (10)

It should be noted that the superscript “e” represents that the symbol denotes an estimate value, and the superscript “a” represents that the symbol denotes an original numerical value. Further, “_err” represents that the symbol denotes an error.

It should be noted that the estimation of the values of the estimatable parameters with use of the formulas 1 through 5 is provided as an example, and if it is possible to estimate the values of the estimatable parameters by any other operation, it is possible to obtain the estimate values of the estimatable parameters by that operation, and to provide the difference values between the estimate values and the respective original numerical values as the compression values.

On the other hand, regarding the non-estimatable parameters, with respect to each of the unit terms, the difference values “δ” between the original numerical values of the non-estimatable parameters in the unit term and the original numerical values of the non-estimatable parameters in the base unit term as the compression values of the non-estimatable parameters.

For example, in FIG. 10, the compression value of the argument of perigee “ω” as the non-estimatable parameter with respect to the GPS satellite “SV1” is a difference value “δω_{—}1.” Further, the compressed value of the mean anomaly “M₀” as the estimatable parameter with respect to the GPS satellite “SV1” is an error “M_{0—}1_err.”

The inventors of the present patent application have found out the fact that the difference values (errors of the estimate values) between the original numerical values and the estimate values take smaller values than the difference values between the both original numeral values as described in “A-GNSS, Orbit Extension.” Based on this finding, regarding the estimatable parameters, the compressed long-term predicted ephemeris is configured using the difference values between the original numerical values in that unit term and the estimate values in that unit term as the compressed values, thereby achieving a reduction in the amount of data.

According to the experiment conducted by the inventors of the present patent application, it has been verified that the amount of data can be reduced as much as at least two bits in every estimatable parameter. In this case, since at least 10 bits of reduction in the amount of data can be obtained in the five estimatable parameters, at least 8960 (=10×32×28) bits (=1120 bytes) of reduction in the amount of data can be obtained in the long-term predicted ephemeris corresponding to 32 satellites and 28 unit terms (=1 week).

### 2-3. Process Flow

FIG. 11 is a view of a flowchart showing the flow of the compressed long-term predicted ephemeris providing process executed in the server system 3 when the compressed long-term predicted ephemeris providing program 341 stored in the ROM 340 is retrieved and executed by the CPU 310.

Firstly, the CPU 310 determines (step A1) whether or not the predicted satellite ephemeris 351 is received from the external system 2, and if it is determined that it has not been received (No in the step A1), the process proceeds to step A5. Further, if it is determined that it has been received (Yes in the step A1), the predicted satellite ephemeris 351 is stored (step A3) in the hard disk 350 as an update.

Subsequently, the CPU 310 determines (step A5) whether or not the time to generate the compressed long-term predicted ephemeris has come. In the present embodiment, it is assumed that the compressed long-term predicted ephemeris is generated every four hours. Further, if it is determined that the generation time has not come (No in the step A5), the CPU 310 makes the process proceed to step A9.

Further, if it is determined that the time to generate the compressed long-term predicted ephemeris has come (Yes in the step A5), the CPU 310 retrieves and executes the compressed long-term predicted ephemeris generation program 3411 stored in the ROM 340, thereby executing (step A7) the compressed long-term predicted ephemeris generation process.

FIGS. 12 and 13 are views of flowcharts showing the flow of the compressed long-term predicted ephemeris generation process.

Firstly, the CPU 310 determines (step B1) each of the unit terms based on the present date and time. Preferably, each of the six-hour terms from the present date and time (generation date and time) up to a week later is determined as the unit term.

Subsequently, the CPU 310 extracts (step B3) the satellite position of each of the GPS satellites SV at each of the time points (the time points of every 15 minutes stored in the predicted satellite ephemeris 351, and included in the unit term) of each of the unit terms determined in the step B1 out of the predicted satellite ephemeris stored in the hard disk 350.

Then, the CPU 310 executes the process of the loop A (steps B5 through B13) with respect to each of the unit terms determined in the step B1. In the loop A, the CPU 310 executes the process of the loop B (steps B7 through B11) with respect to each of the GPS satellites SV.

In the loop B, the CPU 310 calculates the satellite orbit based on the Kepler elliptical orbit model using the satellite positions of the GPS satellite SV at each of the time points of the unit term, and sets (step B9) the satellite orbital parameter values as the original numerical values. It should be noted that the specific calculation method of the satellite orbit is known to the public, and therefore, the explanations therefor will be omitted. Subsequently, the CPU 310 makes the process proceed to the next GPS satellite SV.

After executing the process of the step B9 for all of the GPS satellites SV, the CPU 310 terminates (step B11) the process of the loop B. After terminating the process of the loop B, the CPU 310 makes the process proceed to the next unit term. Then, after executing the process of the steps B7 through B11 for all of the unit terms, the CPU 310 terminates (step B13) the process of the loop A.

After terminating the process of the loop A, the CPU 310 coordinates the original numerical values of the satellite orbital parameters thus obtained to generate the complete long-term predicted ephemeris 354, and then stores (step B15) it as the complete long-term predicted ephemeris data 352 in the hard disk 350 as an update so as to correspond to the generation date and time 353.

Referring now to FIG. 13, subsequently, the CPU 310 executes the process of the loop C (steps B17 through B27) with respect to each of the unit terms other than the base unit term. In the loop C, the CPU 310 executes the process of the loop D (steps B19 through B25) with respect to each of the GPS satellites SV.

In the loop D, the CPU 310 calculates (step B21) the compressed values with respect to each of the estimatable parameters. Specifically, the estimate values of the respective estimatable parameters in the unit term are calculated using the formulas 1 through 5. Subsequently, the errors of the estimate values of the respective estimatable parameters are calculated using the formulas 6 through 10 as the compressed values.

Subsequently, the CPU 310 calculates (step B23) the compressed values with respect to each of the non-estimatable parameters. Specifically, the CPU 310 calculates, as the compressed values, the differences between the original numerical values of the non-estimatable parameters in the unit term, which are included in the complete long-term predicted ephemeris 354 generated in the step B15, and the original numerical values of the non-estimatable parameters in the base unit term.

Subsequently, the CPU 310 makes (step B25) the process proceed to the next GPS satellite SV. After executing the process of the steps B21 and B23 for all of the GPS satellites SV, the CPU 310 terminates (step B25) the process of the loop D.

After terminating the process of the loop D, the CPU 310 makes the process proceed to the next unit term. Then, after executing the process of the steps B19 through B25 for all of the unit terms other than the base unit term, the CPU 310 terminates (step B27) the process of the loop C.

After terminating the process of the loop C, the CPU 310 coordinates the compressed values of the satellite orbital parameters thus obtained to generate the compressed long-term predicted ephemeris 358, and then stores (step B29) it as the compressed long-term predicted ephemeris data 356 in the hard disk 350 as an update so as to correspond to the generation date and time 357. Then, the CPU 310 terminates the compressed long-term predicted ephemeris generation process.

Returning to the compressed long-term predicted ephemeris providing process shown in FIG. 11, after executing the compressed long-term predicted ephemeris generation process, the CPU 310 determines (step A9) whether or not the request signal of the compressed long-term ephemeris has been received from the portable phone 4. Then, if it is determined that it has not been received (No in the step A9), the process returns to the step A1.

Further, if it is determined that the request signal has been received (Yes in the step A9), the CPU 310 transmits (step A11) the compressed long-term predicted ephemeris data 356 stored in the hard disk 350 to the portable phone 4 as the source of the request. Then, the CPU 310 returns to the step A1.

### 3. Portable Phone

### 3-1. Functional Configuration

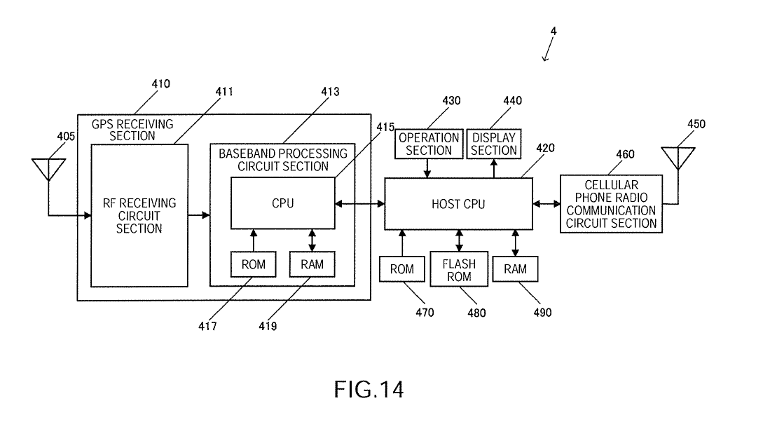

FIG. 14 is a view of a block diagram showing a functional configuration of the portable phone 4. The portable phone 4 is configured including a GPS antenna 405, a GPS receiving section 410, a host CPU 420, an operation section 430, a display section 440, a mobile phone antenna 450, a mobile phone radio communication circuit section 460, a ROM 470, a flash ROM 480, and a RAM 490.

The GPS antenna 405 is an antenna that receives radio frequency (RF) signals including the GPS satellite signals transmitted from the GPS satellites SV, and outputs the signals, thus received, to the GPS receiving section 410. It should be noted that the GPS satellite signal is preferably a communication signal of 1.57542[GHz] modulated by the direct sequence spread spectrum method with the pseudo random noise (PRN) code, which is a type of spread code different between the satellites. The PRN code is a pseudo random noise code having a code length of 1023 chips as 1 PN frame and a repetition period of 1 ms.

The GPS receiving section 410 is a positioning circuit that performs positioning based on the signal output from the GPS antenna 405, and is a functional block corresponding to a so-called GPS receiver. The GPS receiving section 410 is configured to include a radio frequency (RF) receiving circuit section 411, and a baseband processing circuit section 413. It should be noted that the RF receiving circuit section 411 and the baseband processing circuit section 413 can be manufactured separately as discrete large scale integration circuits (LSI), or manufactured integrally as one chip.

The RF receiving circuit section 411 is a processing circuit block that receives RF signals, and divides or multiplies a predetermined locally-generated signal, thereby generating the oscillation signal for RF signal multiplication. Then, the RF receiving circuit section 411 multiplies the oscillation signal, thus generated, by the RF signal output from the GPS antenna 405, thereby down-converting the RF signal into a signal (hereinafter referred to as an “intermediate frequency (IF) signal”) with an intermediate frequency. Then, after amplifying the IF signal, the RF receiving circuit section 411 converts the IF signal into a digital signal with an analog-to-digital (A/D) converter, and then outputs it to the baseband processing circuit section 413.

The baseband processing circuit section 413 is a circuit section that executes a correlation process or the like on the IF signal output from the RF receiving circuit section 411 to capture and to extract the GPS satellite signal. The baseband processing circuit section 413 is configured to include a CPU 415 as a processor, and a ROM 417 and a RAM 419 as memory devices. The CPU 415 captures and extracts the GPS satellite signal using the complete long-term predicted ephemeris obtained by the host CPU 420 expanding the compressed long-term predicted ephemeris.

The host CPU 420 is a processor that integrally controls each of the sections of the portable phone 4 along various kinds of programs such as a positioning calculation program or a system program stored in the ROM 470. The host CPU 420 decodes the data of the GPS satellite signal captured and extracted by the baseband processing circuit section 413 to retrieve therefrom a navigation message, time information, and so on, thereby executing positioning calculation. Subsequently, the host CPU 420 displays the navigation screen plotting the positioning location obtained by the positioning calculation on the display section 440.

The operation section 430 is an input device composed, for example, of a touch panel and button switches, and outputs to the host CPU 420 the signals corresponding to the icons and buttons selected or held down. By operating the operation section 430, various kinds of instruction inputs such as a call request, transmission or reception request of an electronic mail, or an activate request of GPS are executed.

The display section 440 is a display device composed of a liquid crystal display (LCD) or the like, and executing various types of display based on the display signal input from the host CPU 420. On the display section 440, the navigation screen, the time information, and so on are displayed.

The cellular phone antenna 450 is an antenna that performs transmission and reception of the cellular phone radio communication signal with the wireless base stations installed by the communication service company of the portable phone 4.

The cellular phone radio communication circuit section 460 is a communication circuit section of the mobile phone mainly composed of an RF conversion circuit, a baseband processing circuit, and so on, and executes modulation and demodulation on the mobile phone radio signal, thereby realizing phone calls, transmission and reception of the electronic mails, and so on.

The ROM 470 is a read only nonvolatile storage device, and stores various programs such as a system program for the host CPU 420 to control the portable phone 4, the positioning calculation program to realize the positioning calculation, and a navigation program to realize the navigation function and data, and so on.

The flash ROM 480 is a readable and writable nonvolatile storage device, and similarly to the ROM 470, stores various programs and data for the host CPU 420 to control the portable phone 4. The data stored in the flash ROM 480 are not lost even by powering down the portable phone 4.

The RAM 490 is a readable and writable volatile storage device, and forms a work area that temporarily stores the system program, the positioning calculation program, and various kinds of processing programs executed by the host CPU 420, in-process data, and process results of the various kinds of processes.

### 3-2. Data Configuration

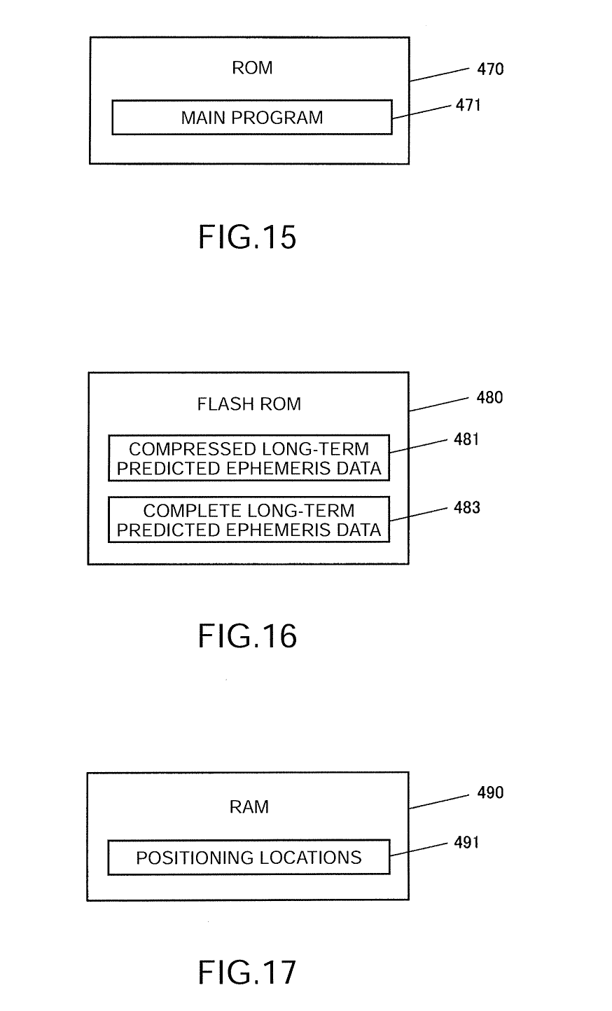

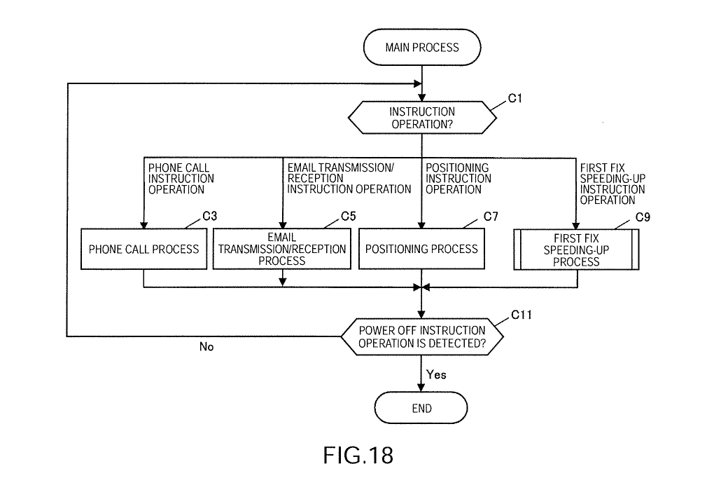

FIG. 15 is a view of a diagram showing an example of the data stored in the ROM 470. The ROM 470 stores the main program 471 retrieved by the host CPU 420 and executed as the main process (see FIG. 18).

The main program denotes a process in which the host CPU 420 executes the original functions as the portable phone 4 such as a process of a phone call or transmission/reception of an email, and further executes a process (the positioning process) that measures the location of the portable phone 4, a process that speeds up the first fix after powering on the portable phone 4, and so on in addition thereto. The main process will be explained later in detail using a flowchart.

FIG. 16 is a view of a diagram showing an example of the data stored in the flash ROM 480. The flash ROM 480 stores the compressed long-term predicted ephemeris data 481 received from the server system 3, and the complete long-term predicted ephemeris data 483 obtained by expanding the compressed long-term predicted ephemeris data.

The data configuration of the compressed long-term predicted ephemeris data 481 is preferably the same as shown in FIGS. 8 through 10. Further, the data configuration of the complete long-term predicted ephemeris data 483 is preferably the same as shown in FIGS. 6 and 7. These data are updated in the main process by the host CPU 420.

FIG. 17 is a view of a diagram showing an example of the data to be stored in the RAM 490. The RAM 490 stores the positioning locations 491 obtained by the positioning process. The positioning locations 491 are updated in the main process by the host CPU 420.

### 3-3. Process Flow

FIG. 18 is a view of a flowchart showing the flow of the main process executed in the portable phone 4 when the host CPU 420 retrieves and executes the main program 471 stored in the ROM 470.

The main process is a process the execution of which is started when the host CPU 420 detects that the power on operation has been executed by the user via the operation section 430. Further, although not specifically explained, it is assumed that while the main process described below is in progress, there is created the state in which reception of the RF signal by the GPS antenna 405 and the down-conversion of the RF signal by the RF receiving circuit section 411 into the IF signal are executed, and the IF signal is output to the baseband processing circuit section 413 as needed.

Firstly, the host CPU 420 discriminates (step C1) the instruction operation executed via the operation section 430, and if it is determined that the instruction operation is a phone call instruction operation (a phone call instruction operation in the step C1), the phone call process is executed (step C3). Specifically, the host CPU 420 makes the cellular phone radio communication circuit section 460 perform the base station communication with the wireless base station, thereby realizing a phone call between the portable phone 4 and another device.

Further, if it is determined in the step C1 that the instruction operation is an electronic mail transmission/reception instruction operation (an email transmission/reception instruction operation in the step C1), the host CPU 420 executes an email transmission/reception process (step C5). Specifically, the host CPU 420 makes the cellular phone radio communication circuit section 460 perform the base station communication, thereby realizing the transmission/reception of the electronic mail between the portable phone 4 and another device.

Further, if it is determined in the step C1 that the instruction operation is a positioning instruction operation (a positioning instruction operation in the step C1), the host CPU 420 executes the positioning process (step C7). Specifically, the host CPU 420 makes the CPU 415 of the baseband processing circuit section 413 perform capturing and extraction of the GPS satellite signal with use of the complete long-term predicted ephemeris 483 stored in the flash ROM 480.

Then, the host CPU 420 retrieves the positioning calculation program from the ROM 470 and executes it to perform a predetermined positioning calculation with use of the GPS satellite signals captured and extracted by the CPU 415, thereby performing positioning. As the positioning calculation, a method known to the public such as positioning calculation using a least-squares method or a Kalman filter can be applied. Subsequently, the host CPU 420 stores the positioning locations 491 obtained by the positioning calculation into the RAM 490.

Further, if it is determined in the step C1 that the instruction operation is a first fix speeding-up instruction operation (a first fix speeding-up instruction operation in the step C1), the host CPU 420 executes a first fix speeding-up process (step C9).

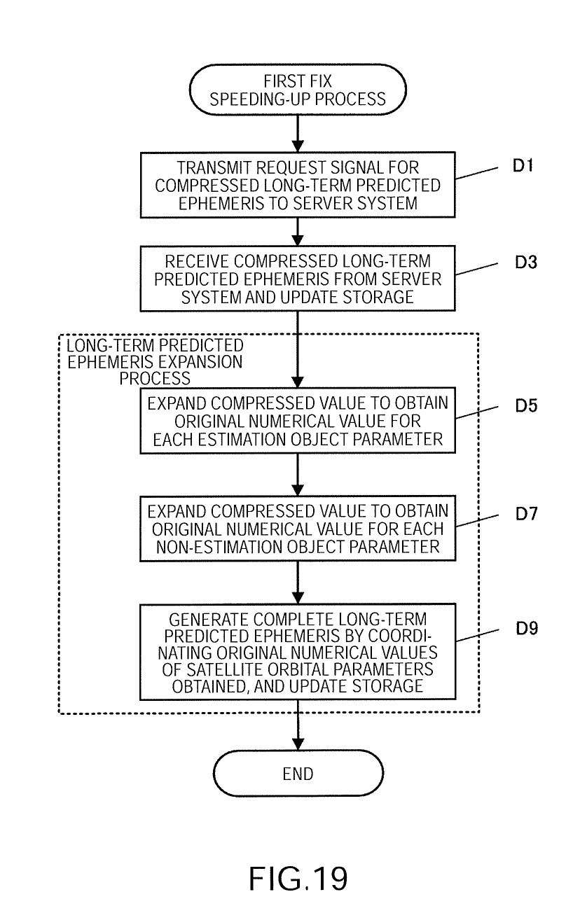

FIG. 19 is a view of a flowchart showing the flow of first fix speeding-up process.

Firstly, the host CPU 420 transmits (step D1) the request signal for the compressed long-term predicted ephemeris to the server system 3. Then, the host CPU 420 receives the compressed long-term predicted ephemeris data 481 from the server system 3, and then stores it into the flash ROM 480 as an update (step D3).

Subsequently, the host CPU 420 performs the long-term predicted ephemeris expansion process (steps D5 through D9). Firstly, with respect to each of the estimatable parameters included in the compressed long-term predicted ephemeris of the compressed long-term predicted ephemeris data 481 received in the step D3, the host CPU 420 expands the compressed value represented by the difference value (the error of the estimate value) between the original numerical value and the estimate value to obtain (step D5) the original numerical value of the estimatable parameter of each of the GPS satellite SV in each of the unit terms.

More specifically, the host CPU 420 calculates the estimate value of each of the estimatable parameters using the formulas 1 through 5 using the original numerical values included in the compressed long-term predicted ephemeris thus received and the compressed value. Then, the host CPU 420 calculates the original numerical values of the estimatable parameters using the formulas 6 through 10 by the use of the estimate values of the estimatable parameters thus calculated and the compressed values (the errors of the estimate values) of the estimatable parameters included in the compressed long-term predicted ephemeris.

Further, with respect to each of the non-estimatable parameters included in the compressed long-term predicted ephemeris, the host CPU 420 expands the compressed value represented by the difference value from the original numerical value in the base unit term to obtain (step D7) the original numerical value of the non-estimatable parameter of each of the GPS satellites SV in each of the unit terms.

Then the host CPU 420 coordinates the original numerical values of the satellite orbital parameters thus obtained to store them as the complete long-term predicted ephemeris into the flash ROM 480 as an update (step D9). Then, the host CPU 420 terminates the first fix speeding-up process.

Returning to the main process shown in FIG. 18, after executing either one of the processes in the steps C3, C5, C7, and C9, the host CPU 420 determines (step C11) whether or not a power off instruction operation has been made by the user via the operation section 430, and if it is determined that the power off instruction operation has not been made (No in the step C11), the process returns to the step C1. Further, if it is determined that the power off instruction operation has been made (Yes in the step C11), the host CPU 420 terminates the main process.

### 4. Functions and Advantages

In the positioning system 1, the server system 3 generates the complete long-term predicted ephemeris having the values of the satellite orbital parameters approximating the satellite orbits of the GPS satellites SV using the Kepler approximation in each of the consecutive unit terms based on the predicted satellite ephemeris received from the external system 2. Then, among the parameters of the complete long-term predicted ephemeris, with respect to the parameters (the estimatable parameters) that can be estimated using the values of objective parameters other than a subjective parameter and the value of the subjective parameter in the previous unit term, the complete long-term predicted ephemeris is compressed by replacing the values of the estimatable parameters with the difference values (the errors of the estimate values) from the estimate values. Subsequently, the server system 3 transmits the compressed long-term predicted ephemeris obtained by compressing the complete long-term predicted ephemeris to the portable phone 4.

The portable phone 4 receives the compressed long-term predicted ephemeris from the server system 3. Then, the portable phone 4 executes the estimation calculation to obtain the estimate value of each of the estimatable parameters, and then calculates the original numerical values of the estimatable parameters using the estimate values thus obtained and the compressed values (the errors of the estimate values) of the estimatable parameters included in the compressed long-term predicted ephemeris, thereby expanding the compressed long-term predicted ephemeris. Subsequently, the portable phone 4 captures the GPS satellites SV using the values of the satellite orbital parameters included in the complete long-term predicted ephemeris obtained by expanding the compressed long-term predicted ephemeris, and then executes a predetermined positioning calculation, thereby measuring the location of the portable phone 4 itself.

As described above, regarding the estimatable parameters among the satellite orbital parameters, the amount of data of the long-term predicted ephemeris can be reduced as a whole by replacing the original numerical values with the errors (the difference values between the original numerical values and the estimate values) of the estimate values with respect to each of the GPS satellites in each of the unit terms.

### 5. Modified Examples

### 5-1. Positioning System

Although in the embodiment described above, the explanations are presented exemplifying the positioning system 1 equipped with the server system 3 and the portable phone 4, the positioning system to which the invention is applied is not limited thereto. The invention can also be applied to the electronic apparatus such as a laptop computer or a personal digital assistant (PDA) equipped with the positioning apparatus, or a vehicle navigation system instead of the portable phone 4.

### 5-2. Satellite Positioning System

Further, in the embodiment described above, although the explanations are presented exemplifying the GPS as the satellite positioning system, other satellite positioning systems such as Wide Area Augmentation System (WAAS), Quasi Zenith Satellite System (QZSS), GLObal NAvigation Satellite System (GLONASS), or GALILEO can also be adopted.

### 5-3. Split of Processing

It is possible to arrange the system such that the CPU 415 executes a part or the whole of the process to be executed by the host CPU 420. For example, it is possible that the CPU 415 requests the compressed long-term predicted ephemeris from the server system 3, and then expands the compressed long-term predicted ephemeris thus obtained to generate the complete long-term predicted ephemeris, thereby capturing and extracting the GPS satellite signals. Further, it is obvious to adopt the configuration such that the host CPU 420 does not execute the positioning calculation, but the CPU 415 executes the positioning calculation instead.

### 5-4. Generation/Provision of Compressed Long-Term Predicted Ephemeris

In the embodiment described above, the explanations are presented assuming that the server system 3 has previously generated the compressed long-term predicted ephemeris in predetermined time intervals (e.g., every four hours), and then transmits the compressed long-term predicted ephemeris in response to the request for the compressed long-term predicted ephemeris from the portable phone 4. Instead of taking such a configuration, it is also possible to arrange the system such that the server system 3 generates the compressed long-term predicted ephemeris and then transmits it to the portable phone 4 upon reception of the request for the compressed long-term predicted ephemeris from the portable phone 4.

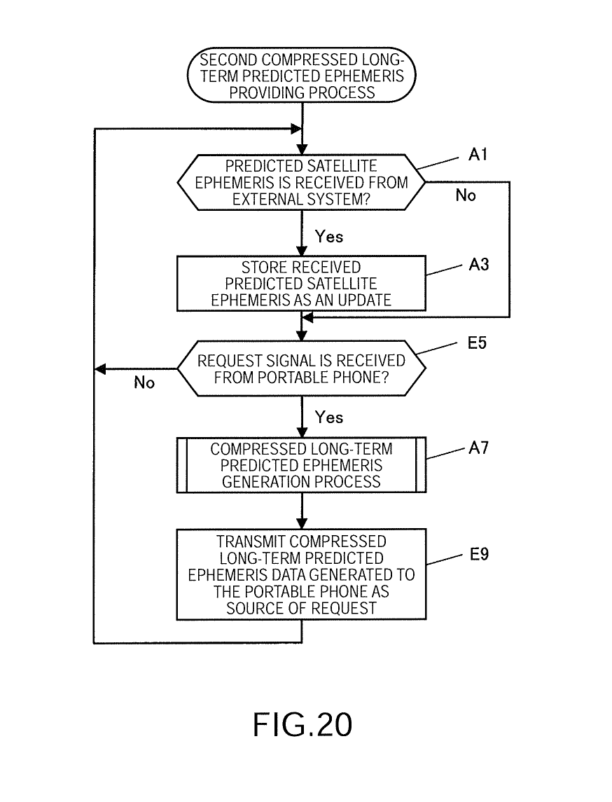

FIG. 20 is a view of a flowchart showing the flow of a second compressed long-term predicted ephemeris providing process the CPU 310 of the server system 3 executes on this occasion. It should be noted that the same steps as in the compressed long-term predicted ephemeris providing process shown in FIG. 11 are denoted with the same reference numerals, and the explanations therefor will be omitted, and the explanations will be presented centering on the different part from the compressed long-term predicted ephemeris providing process.

In the second compressed long-term predicted ephemeris providing process, when receiving the request signal from the portable phone 4 (Yes in step E5), the CPU 310 executes the compressed long-term predicted ephemeris generation process to generate (step A7) the compressed long-term predicted ephemeris. The compressed long-term predicted ephemeris generation process is preferably as explained in FIGS. 12 and 13. Then, the CPU 310 transmits (step E9) the compressed long-term predicted ephemeris data 356 thus generated to the portable phone 4 as the source of the request, and the process returns to the step A1.

### 5-5. Data Configuration of Compressed Long-Term Predicted Ephemeris

Although in the embodiment described above the explanations are presented assuming that the compressed long-term predicted ephemeris is configured using the errors of the estimate values of the estimatable parameters and the differences of the original numerical values of the non-estimatable parameters as the compressed values, it is also possible to configure the compressed long-term predicted ephemeris using the original numerical values instead of the compressed values with respect to the non-estimatable parameters. It should be noted that the amount of data becomes larger in this case in comparison with the embodiment described above.

### 5-6. Approximation Model of Satellite Orbit

Although in the embodiment described above the explanations are presented assuming that the satellite orbit of the GPS satellite is calculated using the Kepler's approximation model, it is also possible to calculate it based on the approximation model such as Lagrange, Neville, or Spline in addition thereto. Specifically, the interpolation polynomial is obtained for each of the GPS satellites using an interpolation technology such as a Lagrange method, a Neville method, or a Spline method using the satellite positions stored in the predicted satellite ephemeris as sample points, thereby approximating the satellite orbit of the GPS satellite.

### 5-7. Prediction Term

Although in the embodiment described above the explanations are presented assuming that the compressed long-term predicted ephemeris is generated taking the generation date and time of the compressed long-term predicted ephemeris as a base, and defining the term therefrom up to a week later as a prediction term, it is also possible to define the prediction term as a term longer than one week (e.g., two weeks), or to define the prediction term as a term shorter than one week (e.g., three days). Although the ephemeris as the navigation data transmitted from the GPS satellite generally has the valid term of about four hours, it is sufficient for the long-term predicted ephemeris to have a longer valid term at least than the ephemeris as the navigation data transmitted from the GPS satellite.

### 5-8. Unit Term

Further, although the explanations are presented assuming that the unit term is formed by dividing the prediction term of the compressed long-term predicted ephemeris by six hours, it is also possible to form the unit term by dividing it by, for example, four hours, and the length of the unit term can suitably be modified.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers, and/or steps. The foregoing also applies to words having similar meanings such as the terms, “including,” “having,” and their derivatives. Also, the terms “part,” “section,” “portion,” “member,” or “element” when used in the singular can have the dual meaning of a single part or a plurality of parts. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

1. (canceled)

2. A compression method of long-term predicted ephemeris including parameters of an approximation formula for approximating a satellite orbit, the compression method comprising:
calculating an estimate value of an estimative parameter with a predetermined calculation, the estimative parameter included in the parameters of the approximation formula; and
compressing the long-term predicted ephemeris by replacing an actual value of the estimative parameter with a difference value between the estimate value and the actual value.

3. The compression method according to claim 2, further comprising:
compressing the long-term predicted ephemeris by replacing an actual value of a non-estimative parameter of a first unit time with a second difference value between the actual value of the non-estimative parameter of the first unit time and an actual value of the non-estimative parameter of a second unit time, the non-estimative parameter included in the parameters of the approximation formula and not being estimative with the predetermined calculation, the second unit time being a different unit time from the first unit time.

4. A decompression method of compressed long-term predicted ephemeris, the decompression method comprising:
acquiring the compressed long-term predicted ephemeris including a difference value between an actual value of an estimative parameter and an estimate value of the estimative parameter, the estimative parameter being estimative with a predetermined calculation;
calculating the estimate value of the estimative parameter with the predetermined calculation; and
decompressing the compressed long-term predicted ephemeris by replacing the difference value with the actual value, the actual value being calculated using the estimate value and the difference value.

5. A positioning apparatus comprising:
an acquisition section adapted to acquire compressed long-term predicted ephemeris including a difference value between an actual value of an estimative parameter and an estimate value of the estimative parameter, the estimative parameter being estimative with a predetermined calculation;
an estimation section adapted to calculate the estimate value of the estimative parameter with the predetermined calculation;
a decompression section adapted to decompress the compressed long-term predicted ephemeris by replacing the difference value with the actual value, the actual value being calculated using the estimate value and the difference value; and
a positioning section adapted to execute positioning using the decompressed long-term predicted ephemeris.
